(19) United States
(12) Patent Application Publication
(10) Pub. No.: US 2007/0207332 A1
(43) Pub. Date: Sep. 6, 2007

(54) Ionomer Compositions suitable for use in antifog applictions

(76) Inventor: John Chu Chen, Hockessin, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/799,561

(22) Filed: May 2, 2007

Related U.S. Application Data
(63) Continuation of application No. 11/127,572, filed on May 12, 2005.
(60) Provisional application No. 60/570,547, filed on May 12, 2004.

(51) Int. Cl. C08F 8/00; B32B 27/00

(52) U.S. Cl. 428/500; 525/192

(57) ABSTRACT

Disclosed are organic acid salt modified potassium ionomeric copolymers that have a unique combination of antistatic, enhanced gas transmission and absorption properties and antifog properties. Films and laminate structures comprising these compositions have excellent gas (e.g. oxygen, water vapor, etc.) absorption and transmission and antifouling (including reduced particulate adhesion due to static charging and reduced fogging) properties.

This application is a continuation of application Ser. No. 11/127,572, filed May 12, 2005 which claimed the benefit of U.S. Provisional Application No. 60/570,547, filed May 12, 2004.

### FIELD OF THE INVENTION

This invention relates to organic acid salt modified potassium ionomeric copolymers that have antifog properties. It also relates to laminates and monolayer or multilayer structures comprising such ionomers.

### BACKGROUND DISCUSSION AND RELATED ART

In general, a melt fabricated article comprised of a polymeric material can become statically charged, the surface of which is often polluted due to adhesion of dusts in the air, the adhesion occurring in the stages of storage, transportation and use. When the fabricated article is, for example, a bag for containing a powder, the appearance of the bag is damaged through the adhesion of contents to the inner surface of the bag and a commodity value may be reduced. For preventing such adhesion of dusts or a powder, various approaches for preventing surface static charge buildup have heretofore been proposed and put in practical use.

### SUMMARY OF THE INVENTION

A first aspect of the invention is a composition comprising:

a blend comprising

(i) at least one E/X/Y copolymer where E is ethylene, X is a C₃ to C₈ α,β ethylenically unsaturated carboxylic acid, and Y is a softening comonomer selected from alkyl acrylate and alkyl methacrylate wherein the alkyl groups have from one to eight carbon atoms, wherein X is about 2-30 weight % of the E/X/Y copolymer and Y is about 0-40 weight % of the E/X/Y copolymer, and

(ii) one or more organic acids or salts thereof; where the combined carboxylic acid functionalities in all ingredients in the blend are at least partially neutralized by potassium.

A second aspect of this invention is an article comprising the composition described above. For example, a laminate comprising a layered structure comprising at least three layers including both surface layers and an intermediate layer, wherein one of the surface layers is comprised of the composition described above.

Another example of an article of the invention is a multilayer container comprising a layer structure comprising at least three layers including both surface layers and an intermediate layer, wherein one of the surface layers is comprised of the composition described above.

Another example of an article of the invention is a monolayer film or multi-layer film comprising the composition of the invention.

### DETAILED DESCRIPTION OF THE INVENTION

All references disclosed herein are incorporated by reference.

“Copolymer” means polymers containing two or more different monomers. The terms “dipolymer” and “terpolymer” mean polymers containing only two and three different monomers respectively. The phrase “copolymer of various monomers” means a copolymer whose units are derived from the various monomers.

Ionomeric resins (“ionomers”) are ionic copolymers of an olefin such as ethylene with a metal salt of an unsaturated carboxylic acid, such as acrylic acid, methacrylic acid, or maleic acid, and optionally softening comonomers. At least one alkali metal, transition metal, or alkaline earth metal cation, such as lithium, sodium, potassium, magnesium, calcium, or zinc, or a combination of such cations, is used to neutralize some portion of the acidic groups in the copolymer resulting in a thermoplastic resin exhibiting enhanced properties. For example, “Ethylene/(meth)acrylic acid (abbreviated E/(M)AA)” means a copolymer of ethylene (abbreviated E)/acrylic acid (abbreviated AA) and/or ethylene/methacrylic acid (abbreviated MAA); which can then be at least partially neutralized by one or more alkali metal, transition metal, or alkaline earth metal cations to form an ionomer. Of particular note are ionomers at least partially neutralized with potassium cations. Terpolymers can also be made from an olefin such as ethylene, an unsaturated carboxylic acid and other comonomers such as alkyl (meth)acrylates providing “softer” resins which can be neutralized to form softer ionomers. Ionomers can also be modified by incorporation of organic acids or salts thereof.

The Antistatic Composition

As noted above, the first aspect of the invention is a composition comprising a blend comprising

(i) at least one E/X/Y copolymer where E is ethylene, X is a C₃ to C₈ α,β ethylenically unsaturated carboxylic acid, and Y is a softening comonomer selected from alkyl acrylate and alkyl methacrylate wherein the alkyl groups have from one to eight carbon atoms, wherein X is about 2-30 weight % of the E/X/Y copolymer and Y is about 0-40 weight % of the E/X/Y copolymer, and

(ii) one or more organic acids or salts thereof; where the combined carboxylic acid functionalities in all ingredients in the blend are at least partially neutralized by potassium.

Ionomers useful in this invention include E/(M)AA dipolymers having from about 2 to about 30 weight % (M)AA with a weight average molecular weight of from about 80,000 to about 500,000, at least partially neutralized by potassium.

Neutralization can be effected by first making the E/(M)AA copolymer and treating the copolymer with inorganic base(s) with alkali metal, alkaline earth metal or transition metal cation(s). The compositions of the invention are at least partially neutralized by potassium, but other cations (e.g. sodium, magnesium or zinc) may also be present in the final compositions of the invention. Other cations are most conveniently incorporated into the composition by neutralizing the E/(M)AA copolymer with such cations at this stage. Methods for preparing ionomers from copolymers are well known in the art. The copolymers are melt-processible, at least partially neutralized copolymers of ethylene and C₃ to C₈ α,β ethylenically unsaturated carboxylic acids.

As indicated above, the ethylene acid ionomers can be melt-blended with other ionomers or polymers and/or modified by incorporation of organic acids or salts thereof. The composition of the invention therefore relates to the above copolymers melt-blended with organic acids or salts thereof, particularly aliphatic, mono-functional organic acid(s) having from 6 to 36 carbon atoms or salts thereof. Preferably, the organic acids are one or more at least partially neutralized, aliphatic, mono-functional organic acids having fewer than 36 carbon atoms or salt thereof. Preferably, greater than 80% of all the acid components in the blend are neutralized, more preferably greater than 90% are neutralized. Most preferably, 100% of all the acid components in the blend are neutralized. As indicated above, the acid components in the composition of the invention are at least partially neutralized by potassium. The organic acids employed in the present invention are particularly those that are non-volatile and non-migratory. Organic acids or organic acid salts are preferred. Non-limiting, illustrative examples of fatty acids are stearic, oleic, erucic and behenic acids. Stearic and oleic acids are preferred.

The organic acids or salts thereof are added in an amount sufficient to enhance the antistatic, gas permeation and antifog properties of the copolymer over the nonmodified copolymer. Preferably, the organic acids or salts are added in an amount of at least about 5% (weight basis) of the total amount of copolymer and organic acid(s). More preferably, the organic acids or salts thereof are added in an amount of at least about 15%, even more preferably at least about 30%. Preferably, the organic acid(s) are added in an amount up to about 50% (weight basis) based on the total amount of copolymer and organic acid. Of note are compositions wherein the organic acids or salts thereof are added in an amount of up to about 45%. Also of note are compositions wherein the organic acids or salts thereof are added in an amount of up to about 40%.

The acid copolymers may optionally contain a third “softening” monomer that disrupts the crystallinity of the polymer. These acid copolymers, when the alpha olefin is ethylene, can be described as E/X/Y copolymers wherein E is ethylene, X is the α,β ethylenically unsaturated carboxylic acid, particularly acrylic and methacrylic acid, and Y is the softening co-monomer. Preferred softening co-monomers are C₁ to C₈ alkyl acrylate or methacrylate esters. X and Y can be present in a wide range of percentages, X typically up to about 35 weight percent (wt. %) of the polymer and Y typically up to about 50 weight percent of the polymer.

The copolymer(s) of alpha olefin, C₃ to C₈ α,β ethylenically unsaturated carboxylic acid and softening monomer from which the melt processible ionomers described above are prepared can be made by methods known in the art. The copolymers include ethylene acid copolymers, such as ethylene/(meth)acrylic acid/n-butyl (meth)acrylate, ethylene/(meth)acrylic acid/iso-butyl (meth)acrylate, ethylene/(meth)acrylic acid/methyl (meth)acrylate, and ethylene/(meth)acrylic acid/ethyl (meth)acrylate terpolymers and particularly ethylene/(meth)acrylic acid/butyl (meth)acrylate copolymers.

Ethylene-acid copolymers with high levels of acid (X) are difficult to prepare in continuous polymerizers because of monomer-polymer phase separation. This difficulty can be avoided however by use of “co-solvent technology” as described in U.S. Pat. No. 5,028,674 or by employing somewhat higher pressures than those at which copolymers with lower acid can be prepared.

Processes for organic acid (salt) modifications are known in the art. Particularly, the modified highly-neutralized acid copolymer ionomers of this invention can be produced by

(a) melt-blending (1) ethylene, α,β ethylenically unsaturated C₃ to C₈ carboxylic acid copolymer(s) or melt-processible ionomer(s) thereof that have their crystallinity disrupted by the optional addition of a softening monomer or other means with (2) sufficient non-volatile, non-migratory organic acids, and concurrently or subsequently

(b) adding a sufficient amount of a source of cations (consisting at least partially of potassium cations) in the presence of added water to achieve the desired level of neutralization of all the acid moieties (including those in the acid copolymer and in the non-volatile, non-migratory organic acids).

The blends of ionomers and organic acids of this invention can be made by melt blending the organic acid (or salt thereof) with a melt processible ionomer made separately and then optionally further neutralizing with the same or different cations to achieve desired levels of neutralization of the resulting blend of ionomer and organic acid. Preferably the non-neutralized terpolymers and organic acids are melt-blended and then neutralized in situ. In this case the desired level of neutralization can be achieved in one step.

For example, ethylene copolymers containing (meth)acrylic acid can be melt blended with either potassium stearate (or potassium salts of other organic acids); or alternatively, with stearic acid (or other organic acids), and neutralized in situ with a potassium cation source to convert the organic acid-modified copolymers into organic acid-modified potassium ionomers of various degrees of neutralization, including 100%.

Compositions with mixed ions could be prepared by treating an already partially neutralized ionomer (or blend thereof) with an excess of an alternate cation source. For example, an ionomer blend at least partially neutralized by sodium can be modified by melt processing with an amount of potassium hydroxide sufficient to neutralize the remaining acid functionalities into an ionomer with a mixture of sodium and potassium ions.

A non-limiting example of melt blending is described here. Employing a Werner & Pfleiderer (W&P) twin screw extruder, the stoichiometric amount of potassium hydroxide in the form of concentrate needed to neutralize the target amount of acid in the acid copolymer and the organic acid (Nominal % Neutralization) is pre-blended with the acid copolymer as a pellet blend. The pellet blend is melt-mixed with the organic acid and neutralized in the W&P twin screw extruder in the presence of added water.

Organic acids that are employed in the present invention include aliphatic, mono-functional (saturated, unsaturated, or multi-unsaturated) organic acids, particularly those having from 6 to 36 carbon atoms. Also salts of these organic acids may be employed. Fatty acids or fatty acid salts are preferred. Particular organic acids useful in the present invention include caproic acid, caprylic acid, capric acid, lauric acid, stearic acid, behenic acid, erucic acid, oleic acid, and linoleic acid. Also of note is the use of branched isomers of stearic and/or oleic acids, such as 2-methyl stearic acid and salts thereof and 2-methyl oleic acid and salts thereof in the present invention. Also preferable for use herein are hydroxyl-acids such as 12-hydroxy stearic acid. Preferably, the potassium salts of these acids are used.

Although the antifog composition may be constituted only of the organic acid salt modified potassium ionomer, another thermoplastic polymer may be blended to the composition unless it affords an adverse influence to the usefulness of the composition or a laminate or coextrusion thereof.

The copolymer can be further blended with one or more conventional ionomeric copolymers (e.g., di-, ter- etc.). The copolymer can be blended with one or more thermoplastic resins. Also, the ionomers of the present invention could be blended with non-ionic thermoplastic resins to manipulate product properties. The non-ionic thermoplastic resins would, by way of non-limiting illustrative examples, include thermoplastic elastomers, such as polyurethane, poly-ether-ester, poly-amide-ether, polyether-urea, PEBAX (a family of block copolymers based on polyether-block-amide, commercially supplied by Atochem); styrene-butadiene-styrene (SBS) block copolymers; styrene(ethylene-butylene)-styrene block copolymers, etc.; polyamides (oligomeric and polymeric); polyesters; polyvinyl alcohol; polyolefins including PE, PP, E/P copolymers, etc.; ethylene copolymers with various comonomers, such as vinyl acetate, (meth)acrylates, (meth)acrylic acid, epoxy-functionalized monomer, CO, vinyl alcohol, etc., functionalized polymers with maleic anhydride grafting, epoxidization etc., elastomers, such as EPDM, metallocene catalyzed PE and copolymer, ground up powders of the thermoset elastomers, etc.

The amount of the thermoplastic polymer blended is preferably 95% by weight or less, more preferably 90% by weight or less, and especially preferably 60% by weight or less of the whole potassium ionomer composition. In other words, it is preferable that the potassium ionomer accounts for 5% by weight or more, more preferably 10% by weight or more and especially preferably 40% by weight or more of the whole composition.

Of note are thermoplastic polymers selected from polymeric materials capable of being employed for surface layers of a laminate such as those described below. Of these materials, preferred is use of olefin-based polymers, especially ethylene-based polymers selected from ethylene homopolymers, copolymers of ethylene and α-olefin having three or more carbon atoms, and copolymers of ethylene and an unsaturated ester such as vinyl acetate and unsaturated carboxylic acid esters. There is no necessity of using virgin materials as such ethylene-based polymers. For example, when an ethylene-based polymer is used for a surface layer, off-specification products or molding wastes such as selvages formed during molding may be recycled.

In the antifog composition, a polyhydroxy compound having two or more alcoholic hydroxyl groups can also be blended in order to improve the properties. Specific examples of such a compound include polyethylene glycols with various molecular weights, polypropylene glycols, polyoxyalkylene glycols such as polyoxyethylene-polyoxypropylene glycol; polyhydric alcohols, such as glycerol, hexanetriol, pentaerythritol and sorbitol, and their ethylene oxide adducts; adducts of a polyvalent amine and an alkylene oxide, etc. The effective blending ratio of the polyhydroxy compound is 15% by weight or less, preferably 10% by weight or less, more preferably 5% by weight or less, and most preferably 0.1% by weight or less, based on the amount of the organic acid salt modified potassium ionomer.

The organic acid salt modified potassium ionomers of this invention also demonstrate useful anti-fog properties. Articles (e.g. films or sheets) prepared from ordinary, nonmodified ionomers have low surface hydrophilicity. In high moisture conditions, the moisture condensed on the surface of the nonmodified ionomer forms tiny water beads that scatter light and reduce the optical transparency of the film (i.e. “fogging”). In contrast, fabricated films or sheets, (prepared by blown film, extrusion casting, injection molding, etc.) of organic acid salt modified potassium ionomer compositions of this invention exhibit sufficient surface hydrophilicity that when exposed to high moisture conditions the moisture condensation effectively wets the surface to form surface coatings that do not scatter light. Thus, potassium stearate (or potassium salts of other organic acids) modified ionomers demonstrate novel anti-fog properties compared to nonmodified ionomers.

The organic acid salt modified potassium ionomers of this invention also exhibit useful gas permeation properties and high moisture vapor transmission and absorption. The enhanced oxygen transmission rate of the compositions of the invention is particularly useful for food packaging applications where the presence of high oxygen content would either improve the appearance of the contents (such as meat) or suppress anaerobic spoilage of the contents (such as fresh seafood). The high water and vapor transmission rates are useful, for example, for preparing articles that can be used to absorb a liquid and then subsequently transfer the liquid to another material. These properties are also useful for applications where removal of aqueous liquids and solutions or water vapor is important to their functions, such as maintaining dryness for comfort in diaper, apparel, protective sheets, medical applications and building constructions.

The compositions of the invention can be used in monolayer or multilayer structures to impart their antifog properties to these structures. For example, the compositions of the invention can be combined with other permeable materials (for example, by lamination or coextrusion) to form structures that can absorb and transmit oxygen and/or moisture such as meat and fish packaging and diaper liners. The compositions of the invention can also be combined with nonabsorptive barrier materials (for example, by lamination or coextrusion) to form structures that can absorb moisture from one side of the structure but prevent it from exiting the other side of the structure. Such structures are useful in packaging and/or processing films for food, and wipes. In some cases it is desirable to combine compositions of the invention with other absorptive materials and impermeable materials to form an absorptive structure that does not allow moisture transmission out of the structure (for example, in packaging, diapers or wipes). The compositions of the invention can also useful in packaging applications such as films, containers, lids and in agricultural films, where antifog properties of the compositions can be desirable.

Examples of the unsaturated carboxylic acid include acrylic acid, methacrylic acid, fumaric acid, maleic anhydride, monomethyl maleate, monoethyl maleate, etc. Particularly preferred are acrylic acid and/or methacrylic acid. Examples of polar monomers that can serve as copolymerization components include vinyl esters such as vinyl acetate and vinyl propionate; unsaturated carboxylic acid esters such as methyl acrylate, ethyl acrylate, isopropyl acrylate, n-butyl acrylate, isobutyl acrylate, n-hexyl acrylate, isooctyl acrylate, methyl methacrylate, dimethyl maleate and diethyl maleate; carbon monoxide; etc. In particular, unsaturated carboxylic acid esters are suitable copolymerization components.

As the ethylene-unsaturated carboxylic acid copolymer as the base polymer of the zinc ionomer, preferred are those having an unsaturated carboxylic acid content of from about 1 to about 25% by weight, especially from about 5 to about 20% by weight. The content of the polar monomer that can be copolymerized is, for example, about 40% by weight or less, preferably about 30% or less. The zinc ionomer is preferably that having a degree of neutralization of from about 10 to about 90%, particularly from about 15 to about 80%. When processability and practical physical properties are taken into consideration, preferred is the use of an ionomer having a melt flow rate, measured at 190° C. and 2160 g load, of from about 0.1 to about 100 g/10 minutes, preferably from about 0.2 to about 50 g/10 minutes.

A laminate of the present invention can be manufactured by laminating individual layers, preferably by extrusion coating, coextrusion or blow molding. Although the thickness of the whole laminate is arbitrary and dependent on its application, it is preferably from about 10 to about 3000 μm, and in particular, from about 20 to about 1000 μm, for example. In the laminate of the present invention, at least one surface layer has a 10% decay time (a time required until the potential decays to +500 V from an applied voltage of +5000 V) of 20 seconds or less, preferably 10 seconds or less, and more preferably 1 second or less, the 10% decay time being measured at 23° C. under an atmosphere of 50% relative humidity. For this purpose, it is preferable that the intermediate layer has a thickness of 5 μm or more, preferably of 10 μm or more, and that the thickness of the surface layer with the decay characteristic indicated above is 500 μm or less, especially 300 μm or less, in terms of the thickness of the surface layer or, if a recovery layer or an adhesive layer is formed, in terms of the total thickness of the surface layer and the additional layer(s). Moreover, when a practical performance is taken into consideration, the ratio of the thickness of the surface layer (or, when a recovery layer or an adhesive layer is formed), the total thickness of the surface layer and the additional layer(s) to the thickness of the intermediate layer is preferably from about 0.1 to about 100 μm, and more preferably from about 0.5 to about 50 μm.

To individual layers may be incorporated various additives as needed, examples of which include antioxidants, light stabilizers, ultraviolet absorbers, pigments, dyes, lubricants, antiblocking agents, inorganic fillers, foaming agents, etc. For example, it is possible to incorporate an organic or inorganic chemical foaming agent such as azodicarbonamide, dinitrosopentamethylenediamine, sulfonylhydrazide, sodium bicarbonate and ammonium bicarbonate at a ratio of from about 0.1 to about 10 parts by weight per 100 parts by weight of the polymer component constituting a layer.

A laminate film of the invention can be prepared by coextrusion as follows: granulates of the various components are melted in suitable extruders and converted into a film using a converting technique. For coextrusion, the molten polymers are passed through a die or set of dies to form layers of molten polymers that are processed as a laminar flow and then cooled to form a layered structure. The film of this invention may also be made by coextrusion followed by lamination onto one or more other layers. Suitable converting techniques include blown film extrusion, cast film extrusion, cast sheet extrusion and extrusion coating. Preferably, a film of the invention is a blown film obtained through blown film extrusion.

The film of the invention can be further oriented beyond the immediate quenching or casting of the film. In general terms the process comprises the steps of coextruding a multilayer laminar flow of molten polymers, quenching the coextrudate and orienting the quenched coextrudate in at least one direction. The film may be uniaxially oriented, but is preferably biaxially oriented by drawing in two mutually perpendicular directions in the plane of the film to achieve a satisfactory combination of mechanical and physical properties.

Orientation and stretching apparatus to uniaxially or biaxially stretch film are known in the art and may be adapted by those skilled in the art to produce films of the present invention. Examples of such apparatus and processes are believed to include e.g. those disclosed in U.S. Pat. Nos. 3,278,663; 3,337,665; 3,456,044; 4,590,106; 4,760,116; 4,769,421; 4,797,235 and 4,886,634.

In a preferred embodiment of the invention, the film is oriented through a double bubble extrusion process, where simultaneous biaxial orientation may be effected by extruding a primary tube which is subsequently quenched, reheated and then expanded by internal gas pressure to induce transverse orientation, and drawn by differential speed nip or conveying rollers at a rate which will induce longitudinal orientation. More particularly, a primary tube is melt extruded from an annular die. This extruded primary tube is cooled quickly to minimize crystallization collapsed. It is then again heated to its orientation temperature (e.g. by means of a water bath). In the orientation zone a secondary tube is formed by inflation, thereby the film is radially expanded in the transverse direction and pulled or stretched in the machine direction at a temperature such that expansion occurs in both directions, preferably simultaneously; the expansion of the tubing being accompanied by a sharp, sudden reduction of thickness at the draw point. The tubular film is then again flattened through nip rolls. The film may be reinflated and pass through an annealing step (thermofixation), during which it is heated once more to adjust the shrink characteristics. For preparing flat films the tubular film can be slit along its length and opened up into flat sheets that can be rolled and/or further processed.

Preferably, the film of the invention can be processed on the manufacturing machine at a speed higher than 50 meters per minute (m/min), and up to a speed of 200 m/min. The film of the invention is therefore compatible with high-speed machines.

Besides wrapping materials, the laminate of the present invention can be used for various applications such as base materials of dicing tapes; adhesive tapes or films for semiconductors such as backgrinding films; electric and electronic materials such as marking films, integrated circuit carrier tapes and tapes for taping electronic components; materials for wrapping foods; medical supplies; protection films (e.g., guard films or sheets for boards and lens of glass, plastics or metal); steel-wire covering materials; cleanroom curtains; wallpapers; mats; flooring materials; inner bags of flexible containers; containers; shoes; battery separators; moisture permeable films; antifouling films; dust-proofing films; PVC-free films; tubes, bottles and the like for packing cosmetics, detergents, shampoo, rinse, etc.

Without further elaboration, it is believed that one skilled in the art using the preceding description can utilize the present invention to its fullest extent. The following Examples are, therefore, to be construed as merely illustrative, and not limiting of the disclosure in any way whatsoever. The methods for the evaluation of the raw materials used and the antifog performances of the resulting laminates in the following Examples and Comparative Examples are shown below.

Materials Used

Ionomer 1 is a terpolymer comprising ethylene, n-butyl acrylate (23.5 weight %) and methacrylic acid (9 weight percent), neutralized with sodium to 52% (nominally) using sodium hydroxide, having a melt index of 1.

Ionomer 2 is a copolymer comprising ethylene and methacrylic acid (10 weight percent), neutralized with sodium to 55% (nominally) using sodium hydroxide, having a melt index of 1.3.

Ionomer 3 is a copolymer comprising ethylene and methacrylic acid (19 weight percent), neutralized with sodium to 37% (nominally) using sodium hydroxide, having a melt index of 2.6.

Ethylene acid copolymer 1 (EAC-1) is a dipolymer comprising ethylene and methacrylic acid (8.7 weight percent), having a melt index of 10.

Ethylene/vinyl acetate copolymer 1 (EVA-1) is a dipolymer comprising ethylene and vinyl acetate (18 weight percent), having a melt index of 2.5.

General Procedures

Employing a Werner & Pfleiderer twin-screw extruder, ionomer 1 was melt blended with potassium stearate at 15 weight %, 30 weight % and 40 weight % to provide Examples 1 through 3. Similarly, ionomer 2 was melt blended with potassium stearate at 15 weight %, 30 weight % and 40 weight % to provide Examples 4 through 6. The compositions were then converted into monolayer blown films about 10 mils in thickness using laboratory scale blown film equipment. The films were tested for their ability to resist fogging by condensation as described below.

TABLE 1

| Example | Resin | Modifier (weight %) | Fogging Test |
|---|---|---|---|
| 1 | Ionomer 1 | K Stearate (15%) | Antifog |
| 2 | Ionomer 1 | K Stearate (30%) | Antifog |
| 3 | Ionomer 1 | K Stearate (40%) | Antifog |
| 4 | Ionomer 2 | K Stearate (15%) | Antifog |
| 5 | Ionomer 2 | K Stearate (30%) | Antifog |
| 6 | Ionomer 2 | K Stearate (40%) | Antifog |

Employing a Werner & Pfleiderer twin-screw extruder, the composition of Example 6 was melt blended with Ionomer 2 at various proportions to provide Examples 7 and 8 (Table 2). The compositions were then converted into monolayer blown films about 3 mils in thickness using laboratory scale blown film equipment. The films were tested for their ability to resist fogging by condensation as described below.

TABLE 2

| | Example 6 | Ionomer 2 | |
|---|---|---|---|
| Example | weight % | weight % | Fogging Test |
| 7 | 25 | 75 | Antifog |
| 8 | 50 | 50 | Antifog |

Employing a Werner & Pfleiderer twin-screw extruder, EAC-1 was melt blended with potassium stearate at 20 weight % to provide Example 9 (Table 3). The composition of Example 9 was blended with EVA-1 at various proportions to provide Examples 11 and 12. Employing a Werner & Pfleiderer twin-screw extruder, EVA-1 was melt blended with potassium stearate at 20 weight % to provide Example 10. The composition of Example 10 was blended with additional EVA-1 to provide Example 13. The compositions were then converted into monolayer blown films about 3 mils in thickness using laboratory scale blown film equipment. The films were examined visually to ascertain their optical properties. Films without an ionomer component were hazy, indicating that potassium salt of the organic acid may not have been evenly dispersed in the composition. The films were tested for their ability to resist fogging by condensation as described below.

TABLE 3

| | Resin | Modifier | Optical | Fogging |
|---|---|---|---|---|
| Example | | (weight %) | Properties | Test |
| 9 | EAC-1 | K Stearate (20%) | Clear | Antifog |
| 10 | EVA-1 | K Stearate (20%) | Hazy | Antifog |
| | First Composition | Added EVA-1 | | |
| Example | (weight %) | weight % | | |
| 11 | Example 9 (50) | 50 | Clear | Antifog |
| 12 | Example 9 (25) | 75 | Clear | Antifog |
| 13 | Example 10 (50) | 50 | Hazy | Antifog |

Employing a Werner & Pfleiderer twin-screw extruder, Ionomer 3 was melt blended with isostearic acid (available as Century 1115 from Arizona Chemicals) at 20 weight %, 30 weight %, 40 weight % and 50 weight %, and neutralized in situ in the presence of a stoichiometric amount of KOH neutralize 100% of all the acid functionalities in the blends to provide Examples 15 through 18, summarized in Table 4. Example 14 was a 50:50 blend of Example 15 and Ionomer 4 to provide a composition having nominally 10 weight % of potassium isostearate. The compositions were converted into monolayer cast films about 3 mils in thickness using a Werner & Pfleiderer twin-screw extruder. The films were tested for their ability to resist fogging by condensation as described below.

TABLE 4

| Example | Resin | Modifier (weight %) | Fogging Test |
|---|---|---|---|
| 14 | Ionomer 3 | K Isostearate (10%) | Antifog |
| 15 | Ionomer 3 | K Isostearate (20%) | Antifog |
| 16 | Ionomer 3 | K Isostearate (30%) | Antifog |
| 17 | Ionomer 3 | K Isostearate (40%) | Antifog |
| 18 | Ionomer 3 | K Isostearate (50%) | Antifog |

Fogging Test

A styrofoam cup is filled with near boiling hot water to about 75% of the volume. The test film is placed over the cup and after a short period of time a visual examination of the film determined whether the film was fogged by condensation. Films that were not fogged are indicated as “antifog.”

What is claimed is:

1. A two-layer laminate having a thickness of about 10 μm to about 3000 μm consisting of
A. a first layer of thickness of 500 μm or less, and
B. a second layer;
wherein said first layer is formed of a blend composition comprising
1. a first component comprising at least one E/X/Y copolymer where E is ethylene, X is a C₃ to C₈ α,β ethylenically unsaturated carboxylic acid, and Y is a softening comonomer selected from the group consisting of alkyl acrylates and alkyl methacrylates wherein the alkyl groups have from one to eight carbon atoms, wherein X is about 2-30 weight % of the E/X/Y copolymer and Y is about 0-40 weight % of the E/X/Y copolymer; and
2. a second component comprising one or more organic acids or salts thereof,
wherein the combined carboxylic acid functionalities of said first and second components are at least partially neutralized by potassium ions.

2. A laminate of claim 1 having a thickness of 1000 μm or less.

3. A laminate of claim 1 wherein the blend composition additionally comprises a polyhydroxy compound having two or more hydroxyl groups.

4. A laminate of claim 1 wherein the blend composition has a 10% decay time of 20 seconds or less, measured at 23° C. under an atmosphere of 50% relative humidity, where 10% decay time is the time required for the potential to decay to +500 volts after application of an applied voltage of 5000 volts to the outer layer.

5. A laminate of claim 1 wherein the blend composition additionally comprises a thermoplastic resin.

6. A laminate of claim 1 wherein at least 80% of the combined carboxylic acid functionalities of said first and second components are neutralized by potassium ions.

7. A laminate of claim 1 wherein at least 90% of the combined carboxylic acid functionalities of said first and second components are neutralized by potassium ions.

8. A laminate of claim 1 wherein 100% of the combined carboxylic acid functionalities of said first and second components are neutralized by potassium ions.

9. A multilayer laminate having a thickness of about 10 μm to about 3000 μm comprising
A. a first outer layer of thickness of 500 μm or less,
B. a second outer layer; and
C. at least one layer of thickness 5 μm or more positioned between said two outer layers,
wherein said first outer layer is formed of a blend composition comprising
1. a first component comprising at least one E/X/Y copolymer where E is ethylene, X is a C₃ to C₈ α,β ethylenically unsaturated carboxylic acid, and Y is a softening comonomer selected from the group consisting of alkyl acrylates and alkyl methacrylates wherein the alkyl groups have from one to eight carbon atoms, wherein X is about 2-30 weight % of the E/X/Y copolymer and Y is about 0-40 weight % of the E/X/Y copolymer; and
2. a second component comprising one or more organic acids or salts thereof,
wherein the combined carboxylic acid functionalities of said first and second components are at least partially neutralized by potassium ions.

10. A multilayer laminate of claim 9 wherein the blend composition additionally comprises a polyhydroxy compound having two or more hydroxyl groups.

11. A multilayer laminate of claim 9 wherein the blend composition has a 10% decay time of 20 seconds or less, measured at 23° C. under an atmosphere of 50% relative humidity, where 10% decay time is the time required for the potential to decay to +500 volts after application of an applied voltage of 5000 volts to the outer layer.

12. A multilayer laminate of claim 9 wherein the blend composition additionally comprises a thermoplastic resin.

13. A multilayer laminate of claim 9 wherein at least 80% of the combined carboxylic acid functionalities of said first and second components are neutralized by potassium ions.

14. A multilayer laminate of claim 1 wherein at least 90% of the combined carboxylic acid functionalities of said first and second components are neutralized by potassium ions.

15. A multilayer laminate of claim 1 wherein 100% of the combined carboxylic acid functionalities of said first and second components are neutralized by potassium ions.

16. A multilayer laminate of claim 11 wherein at least 80% of the combined carboxylic acid functionalities of said first and second components are neutralized by potassium ions.

17. A multilayer laminate of claim 11 wherein at least 90% of the combined carboxylic acid functionalities of said first and second components are neutralized by potassium ions.

18. A multilayer laminate of claim 11 wherein 100% of the combined carboxylic acid functionalities of said first and second components are neutralized by potassium ions.

19. A multilayer laminate of claim 9 wherein the second component is selected from the group consisting of stearic acid, iso-stearic acid, erucic acid, behenic acid, oleic acid, salts of stearic acid, salts of erucic acid, salts of behenic acid, salts of oleic acid and mixtures thereof.

20. A multilayer laminate of claim 11 wherein the second component is selected from the group consisting of stearic acid, erucic acid, behenic acid, oleic acid, salts of stearic acid, salts of erucic acid, salts of behenic acid, salts of oleic acid and mixtures thereof.

21. A monolayer film having a thickness of 500 μm or less comprising
A. a first component comprising at least one E/X/Y copolymer where E is ethylene, X is a C₃ to C₈ α,β ethylenically unsaturated carboxylic acid, and Y is a softening comonomer selected from the group consisting of alkyl acrylates and alkyl methacrylates wherein the alkyl groups have from one to eight carbon atoms, wherein X is about 2-30 weight % of the E/X/Y copolymer and Y is about 0-40 weight % of the E/X/Y copolymer; and
B. a second component comprising one or more organic acids or salts thereof,
wherein the combined carboxylic acid functionalities of said first and second components are at least partially neutralized by potassium ions and wherein the film has a 10% decay time of 20 seconds or less, measured at 23° C. under an atmosphere of 50% relative humidity, where 10% decay time is the time required for the potential to decay to +500 volts after application of an applied voltage of 5000 volts.

22. A film of claim 21 wherein the blend composition has a 10% decay time of 20 seconds or less, measured at 23° C. under an atmosphere of 50% relative humidity, where 10% decay time is the time required for the potential to decay to +500 volts after application of an applied voltage of 5000 volts to the outer layer.

23. An article comprising a laminate of claim 1.

24. An article comprising a laminate of claim 9.

25. An article comprising a laminate of claim 11.

26. An article comprising a monolayer film of claim 21.
